(19) United States
(12) Patent Application Publication
(10) Pub. No.: US 2025/0171572 A1
(43) Pub. Date: May 29, 2025

(54) TRANSITION METAL COMPOUND, CATALYST COMPOSITION INCLUDING THE SAME, AND METHOD FOR PREPARING OLEFIN POLYMER USING THE SAME

(71) Applicant: SABIC SK NEXLENE COMPANY PTE. LTD., Singapore (SG)

(72) Inventors: Dongcheol SHIN, Daejeon (KR); Yeonock OH, Daejeon (KR); Minji KIM, Daejeon (KR); Miji KIM, Daejeon (KR); Sang Bae CHEONG, Daejeon (KR); Dong Kyu PARK, Daejeon (KR); Choon Sik SHIM, Daejeon (KR); Minho JEON, Daejeon (KR); Dae Ho SHIN, Daejeon (KR)

(21) Appl. No.: 18/725,476

(22) PCT Filed: Dec. 28, 2022
(86) PCT No.: PCT/IB2022/062828

§ 371 Date: Jun. 28, 2024

(30) Foreign Application Priority Data
Dec. 29, 2021 (KR) 10-2021-0190585
Dec. 21, 2022 (KR) 10-2022-0180458

(51) Int. Cl. C08F 210/16; C07F 7/00

(52) U.S. Cl. CPC C08F 210/16; C07F 7/00; C08F 2420/03

(57) ABSTRACT

Provided are a transition metal compound. a catalyst composition including the same, and a method for preparing an olefin polymer using the same. The transition metal compound of the present invention in which a specific functional group is introduced to a specific position has high solubility and catalytic activity. and in the method for preparing an olefin polymer using the transition metal compound. an olefin polymer having excellent physical properties may be easily prepared by a simple process.

### TECHNICAL FIELD

The following disclosure relates to a transition metal compound, a catalyst composition including the same, and a method for preparing an olefin polymer using the same, and more particularly, to a transition metal compound having improved solubility by introducing a controlled specific functional group, a catalyst composition including the same, and a method for preparing an olefin polymer using the same.

### BACKGROUND ART

Conventionally, in the preparation of a homopolymer of ethylene or copolymers of ethylene and α-olefins, so called, a Ziegler-Natta catalyst system including a main catalyst component of a titanium or vanadium compound, and a cocatalyst component of an alkyl aluminum compound has been used.

However, though the Ziegler-Natta catalyst system shows high activity in ethylene polymerization, it has a demerit in that generally a produced polymer has a broad molecular weight distribution due to a heterogeneous catalytic active site, and in particular copolymers of ethylene and α-olefins have a non-uniform composition distribution.

Recently, so called, a metallocene catalyst system including a metallocene compound of Group 4 transition metals in the periodic table such as titanium, zirconium and hafnium and methylaluminoxane as a cocatalyst has been developed. Since the metallocene catalyst system is a homogeneous catalyst having a single catalyst active site, it is characterized by preparing polyethylene having a narrow molecular weight distribution and a uniform composition distribution as compared with the conventional Ziegler-Natta catalyst system.

As a specific example, ethylene is polymerized with high activity by activating a metallocene compound such as Cp₂TiCl₂, Cp₂ZrCl₂, Cp₂ZrMeCl, Cp₂ZrMe₂, ethylene(IndH₄)₂ZrCl₂, etc., with methylaluminoxane as a cocatalyst, thereby preparing polyethylene having a narrow molecular weight distribution (Mw/Mn).

However, it is difficult to obtain a high molecular polymer with the metallocene catalyst system. In particular, when the metallocene catalyst system is applied to a solution polymerization which is carried out at a high temperature of 100° C. or more, polymerization activity is rapidly decreased and a β-dehydrogenation reaction is pre-dominant, and thus, the metallocene catalyst system is not suitable for preparing a high molecular weight polymer having a high weight average molecular weight (Mw).

Meanwhile, it was known that as a catalyst capable of preparing a polymer having a high catalyst activity and a high molecular weight by homopolymerization of ethylene or copolymerization of ethylene and α-olefin under a solution polymerization condition of 100° C. or more, a so-called geometrically constrained ANSA-type metallocene-based catalyst in which a transition metal is linked in a ring form may be used. The ANSA-type metallocene-based catalyst has significantly improved octene-injection and high-temperature activity compared to the metallocene catalyst. Nevertheless, most of the previously known ANSA-type metallocene-based catalyst include a Cl functional group or include a methyl group or the like, and thus have a problem to be improved for use in a solution process.

Since the Cl functional group substituted in the catalyst may cause corrosion, etc. depending on the material of the process equipment used in the process, a study has been conducted on the ANSA-type metallocene-based catalyst substituted with dimethyl in order to avoid the problem of corrosion caused by Cl. However, the ANSA-type metallocene-based catalyst is also difficult to inject into the polymerization process due to its poor solubility. Toluene or xylene can be used to dissolve these catalysts having poor solubility, but the use of aromatic solvents such as toluene or xylene causes problems in the case of producing products that are likely to come into contact with food.

Therefore, a study of a competitive catalyst having characteristics such as excellent solubility, activity at a high temperature, reactivity with higher α-olefin, and ability to prepare high molecular weight polymer is desperately needed.

### DISCLOSURE OF INVENTION

### Technical Problem

An embodiment of the present invention is directed to providing a transition metal compound to which a controlled specific functional group is introduced for improving the above problems and a catalyst composition including the same.

An embodiment of the present invention is directed to providing a method for preparing an olefin polymer using the transition metal compound of the present invention as a catalyst.

### Solution to Problem

In one general aspect, a transition metal compound having significantly improved solubility in a non-aromatic hydrocarbon is provided, and the transition metal compound of the present invention is represented by the following Chemical Formula 1:

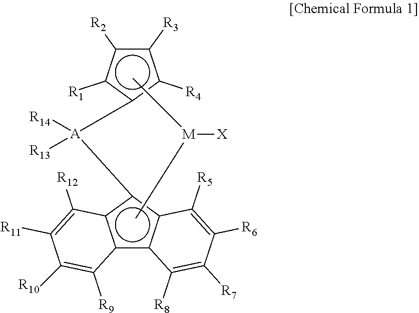

wherein
M is a Group 4 transition metal in the periodic table;
A is carbon or silicon;
R₁ to R₄ are independently of one another hydrogen or C₁-C₂₀alkyl;
R₅ to R₁₂ are independently of one another hydrogen, C₁-C₂₀alkyl, C₁-C₂₀alkoxy, C₃-C₂₀cycloalkyl, C₆-C₂₀aryl, C₆-C₂₀arylC₁-C₂₀alkyl, C₁-C₂₀alkylC₆-C₂₀aryl, triC₁-C₂₀ alkylsilyl, or triC₆-C₂₀arylsilyl, or each of the R₅ to R₁₂ may be linked to an adjacent substituent via C₃-C₁₂alkylene or C₃-C₁₂alkenylene with or without a fused ring to form an alicyclic ring or form a monocyclic or polycyclic aromatic ring;
R₁₃ and R₁₄ are independently of each other C₆-C₂₀aryl;
X is conjugated or non-conjugated C₄-C₂₀diene;
the diene may be further substituted by one or two or more substituents selected from
the group consisting of C₁-C₂₀alkyl, C₃-C₂₀cycloalkyl, C₆-C₂₀aryl, C₆-C₂₀arylC₁-C₂₀ alkyl, C₁-C₂₀alkylC₆-C₂₀aryl, C₁-C₂₀alkoxy, C₆-C₂₀aryloxy, triC₁-C₂₀alkylsilyl, and triC₆-C₂₀arylsilyl; and
the diene forms a π-complex with a central metal M.

Preferably, in Chemical Formula 1 according to an exemplary embodiment of the present invention, M may be a Group 4 transition metal in the periodic table; A may be carbon or silicon; R₁ to R₄ may be independently of one another hydrogen or C₁-C₁₀ alkyl; R₅ to R₁₂ may be independently of one another hydrogen, C₁-C₁₀alkyl, C₁-C₁₀ alkoxy, C₃-C₁₀cycloalkyl, C₆-C₁₀aryl, C₆-C₁₀arylC₁-C₁₀alkyl, C₁-C₁₀alkylC₆-C₁₀aryl, triC₁-C₁₀alkylsilyl, or triC₆-C₁₀arylsilyl, or each of the R₅ to R₁₂ may be linked to an adjacent substituent via C₃-C₁₂alkylene or C₃-C₁₂alkenylene with or without a fused ring to form an alicyclic ring or form a monocyclic or polycyclic aromatic ring; R₁₃ and R₁₄ may be independently of each other C₆-C₁₀aryl; X may be conjugated or non-conjugated C₄-C₁₀diene; the diene may be further substituted by one or two or more substituents selected from the group consisting of C₁-C₁₀alkyl, C₃-C₁₀cycloalkyl, C₆-C₁₀ aryl, C₆-C₁₀arylC₁-C₁₀alkyl, C₁-C₁₀alkylC₆-C₁₀aryl, C₁-C₁₀alkoxy, C₆-C₁₀aryloxy, triC₁-C₁₀alkylsilyl, and triC₆-C₁₀arylsilyl; and the diene may form a π-complex with a central metal M.

More preferably, in Chemical Formula 1 according to an exemplary embodiment of the present invention, M may be Ti, Zr, or Hf; A may be carbon or silicon; R₁ to R₄ may be independently of one another hydrogen or C₁-C₄alkyl; R₅ to R₁₂ may be independently of one another hydrogen, C₁-C₄alkyl, or C₁-C₄alkoxy; R₁₃ and R₁₄ may be independently of each other C₆-C₁₀aryl; X may be conjugated or non-conjugated C₄-C₇ diene; the diene may be further substituted by one or two or more substituents selected from the group consisting of C₁-C₁₀alkyl, C₃-C₁₀cycloalkyl, C₆-C₁₀aryl, C₆-C₁₀arylC₁-C₁₀alkyl, C₁-C₁₀alkylC₆-C₁₀aryl, C₁-C₁₀alkoxy, C₆-C₁₀aryloxy, triC₁-C₁₀alkylsilyl, and triC₆-C₁₀arylsilyl; and the diene may form a π-complex with a central metal M.

In an exemplary embodiment of the present invention, the transition metal compound may be represented by the following Chemical Formula 2:

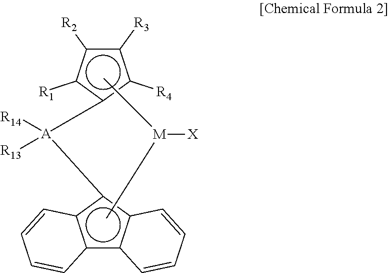

wherein
M is Ti, Zr, or Hf;
A is carbon or silicon;
R₁ to R₄ are independently of one another hydrogen or C₁-C₄alkyl;
R₁₃ and R₁₄ are independently of each other C₆-C₁₀aryl;
X is

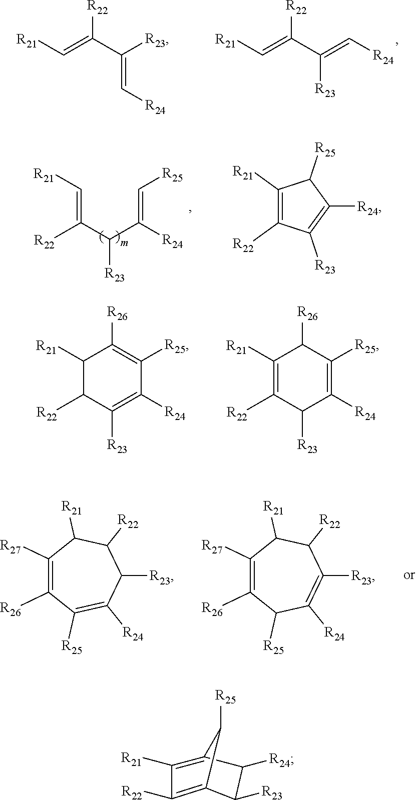

R₂₁ to R₂₇ are independently of one another hydrogen, C₁-C₁₀alkyl, C₃-C₁₀cycloalkyl, C₆-C₁₀aryl, C₆-C₁₀arylC₁-C₁₀alkyl, C₁-C₁₀alkylC₆-C₁₀aryl, C₁-C₁₀alkoxy, C₆-C₁₀aryloxy, triC₁-C₁₀alkylsilyl, or triC₆-C₁₀arylsilyl;
m is an integer of 1 to 3; and
X forms a π-complex with a central metal M.

Specifically, in an exemplary embodiment of the present invention, the transition metal compound may be selected from the following compounds:

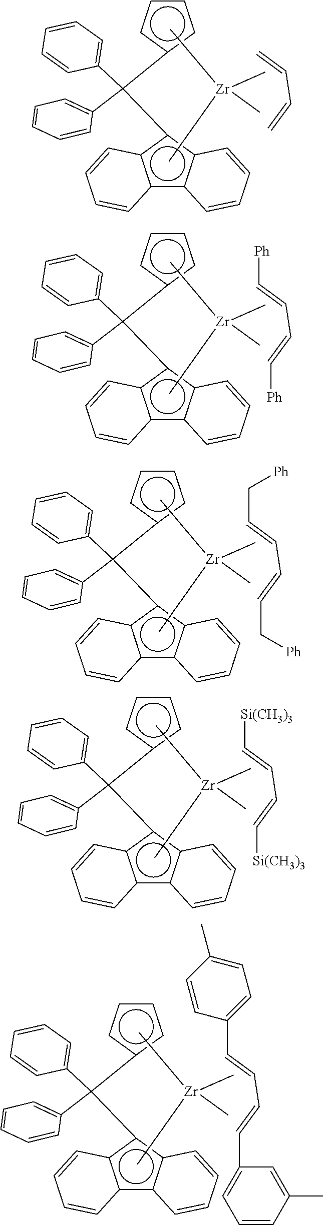

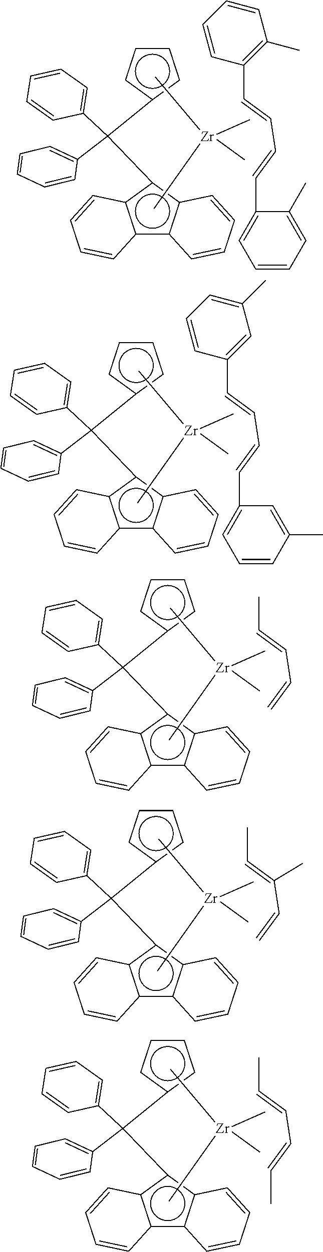

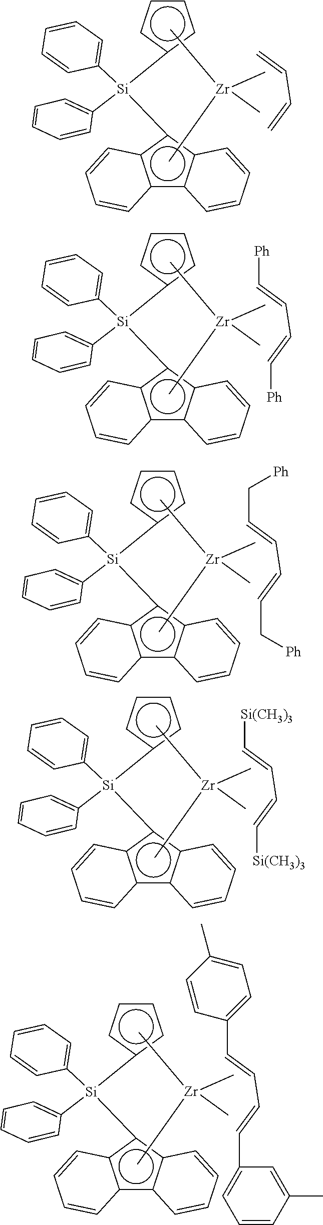

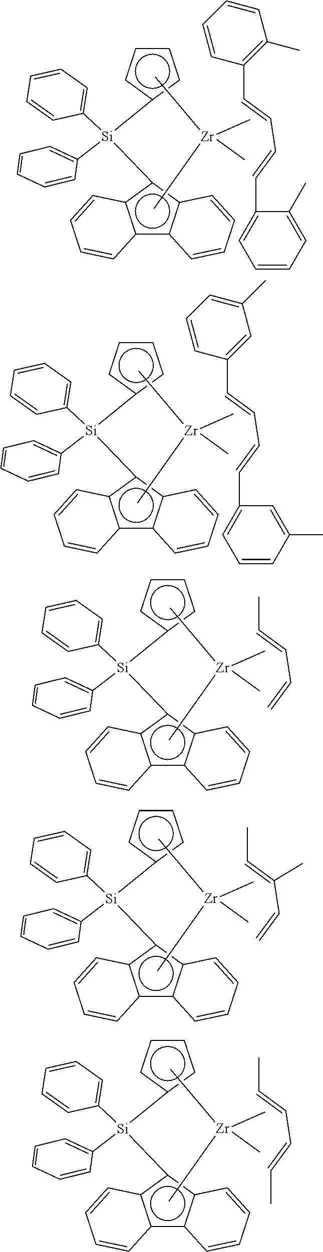

The transition metal compound according to an exemplary embodiment of the present invention may have a solubility in methylcyclohexane of 5 wt % or more at 25° C.

In another general aspect, a transition metal catalyst composition for preparing an ethylene homopolymer or a copolymer of ethylene and α-olefin including the transition metal compound according to the present invention is provided, and the transition metal catalyst composition includes: a transition metal compound represented by the following Chemical Formula 1; and a cocatalyst:

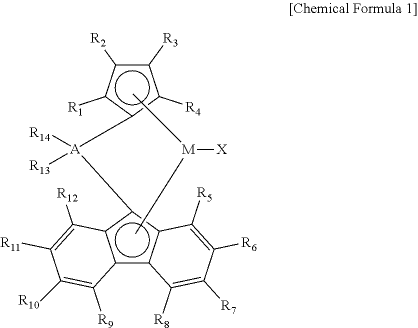

wherein
M is a Group 4 transition metal in the periodic table;
A is carbon or silicon;
R₁ to R₄ are independently of one another hydrogen or C₁-C₂₀alkyl;
R₅ to R₁₂ are independently of one another hydrogen, C₁-C₂₀alkyl, C₁-C₂₀alkoxy, C₃-C₂₀cycloalkyl, C₆-C₂₀aryl, C₆-C₂₀arylC₁-C₂₀alkyl, C₁-C₂₀alkylC₆-C₂₀aryl, triC₁-C₂₀ alkylsilyl, or triC₆-C₂₀arylsilyl, or each of the R₅ to R₁₂ may be linked to an adjacent substituent via C₃-C₁₂alkylene or C₃-C₁₂alkenylene with or without a fused ring to form an alicyclic ring or form a monocyclic or polycyclic aromatic ring;
R₁₃ and R₁₄ are independently of each other C₆-C₂₀aryl;
X is conjugated or non-conjugated C₄-C₂₀diene;
the diene may be further substituted by one or two or more substituents selected from the group consisting of C₁-C₂₀alkyl, C₃-C₂₀cycloalkyl, C₆-C₂₀aryl, C₆-C₂₀arylC₁-C₂₀ alkyl, C₁-C₂₀alkylC₆-C₂₀aryl, C₁-C₂₀alkoxy, C₆-C₂₀aryloxy, triC₁-C₂₀alkylsilyl, and triC₆-C₂₀arylsilyl; and
the diene forms a π-complex with a central metal M.

The cocatalyst included in the transition metal catalyst composition may be an aluminum compound cocatalyst, a boron compound cocatalyst, or a mixture thereof.

In still another general aspect, a method for preparing an olefin polymer using the transition metal compound according to the present invention is provided.

The method for preparing an olefin polymer includes: obtaining an olefin polymer by solution polymerization of one or two or more monomers selected from ethylene and α-olefins in the presence of a transition metal compound represented by Chemical Formula 1, a cocatalyst, and a non-aromatic hydrocarbon solvent.

The non-aromatic hydrocarbon solvent may be one or two or more selected from the group consisting of methylcyclohexane, cyclohexane, n-heptane, n-hexane, n-butane, isobutane, n-pentane, n-octane, isooctane, nonane, decane, and dodecane, and a solubility of the transition metal compound according to an exemplary embodiment of the present invention in the non-aromatic hydrocarbon solvent may be 5 wt % or more at 25° C.

Preferably, in the method for preparing an olefin polymer according to an exemplary embodiment of the present invention, the cocatalyst may be an aluminum compound cocatalyst, a boron compound cocatalyst, or a mixture thereof, and specifically, the boron compound cocatalyst may be one or a mixture of two or more selected from compounds represented by the following Chemical Formulae 11 to 14, and the aluminum compound cocatalyst may be one or a mixture of two or more selected from compounds represented by the following Chemical Formulae 15 to 19:

BR³¹₃ [Chemical Formula 11]

[R³²]⁺[BR³¹₄]⁻ [Chemical Formula 12]

[R³³ₚZH]⁺[BR³¹₄]⁻ [Chemical Formula 13]

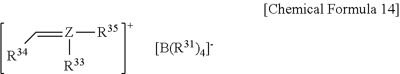

wherein
B is a boron atom;
R³¹ is phenyl, and the phenyl may be further substituted by 3 to 5 substituents selected from the group consisting of a fluorine atom, C₁-C₂₀alkyl, C₁-C₂₀alkyl substituted by a fluorine atom, C₁-C₂₀alkoxy, and C₁-C₂₀alkoxy substituted by a fluorine atom;
R³² is a C₅-C₇ aromatic radical, a C₁-C₂₀alkylC₆-C₂₀aryl radical, or a C₆-C₂₀arylC₁-C₂₀ alkyl radical;
Z is nitrogen or a phosphorous atom;
R³³ is a C₁-C₂₀alkyl radical or an anilinium radical substituted by two C₁-C₁₀alkyls together with a nitrogen atom;
R³⁴ is C₅-C₂₀alkyl;
R³⁵ is C₅-C₂₀aryl or C₁-C₂₀alkylC₆-C₂₀aryl; and
p is an integer of 2 or 3,

—(Al(R⁴¹)—O)ᵣ— [Chemical Formula 15]

(R⁴²)₂Al—(—O(R⁴²)—)₈—O—Al(R⁴²)₂ [Chemical Formula 16]

(R⁴³)ₜAl(E)₃₋ₜ [Chemical Formula 17]

(R⁴⁴)₂AlOR⁴⁵ [Chemical Formula 18]

R⁴⁴Al(OR⁴⁵)₂ [Chemical Formula 19]
wherein
R⁴¹ and R⁴² are independently of each other C₁-C₂₀alkyl;
r and s are independently of each other an integer of 5 to 20;
R⁴³ and R⁴⁴ are independently of each other C₁-C₂₀alkyl;
E is hydrogen or halogen;
t is an integer of 1 to 3; and
R⁴⁵ is C₁-C₂₀alkyl or C₆-C₃₀aryl.

Preferably, in the method for preparing an olefin polymer according to an exemplary embodiment of the present invention, the solution polymerization may be performed at 100 to 220° C.

### Advantageous Effects of Invention

The transition metal compound according to the present invention has significantly improved solubility in a non-aromatic hydrocarbon solvent by introducing a controlled specific functional group, and thus, catalytic activity is high and the catalytic activity may remain without being decreased during solution polymerization.

Besides, the transition metal compound according to the present invention may be easily injected and transferred during a solution process by introducing a specific functional group to a specific position, thereby significantly improving a polymerization process, and thus, may be very advantageous for commercialization.

In addition, since the transition metal compound according to the present invention has excellent solubility in a non-aromatic hydrocarbon solvent, it has excellent re-activity with olefins, so that it is easy to polymerize olefins and the yield of olefin polymers is high, and thus, a catalyst composition including the transition metal compound according to an exemplary embodiment of the present invention may be industrially useful in the method for preparing an olefin polymer having excellent physical properties.

The method for preparing an olefin polymer according to the present invention uses the transition metal compound of the present invention having excellent solubility in a non-aromatic hydrocarbon solvent, whereby the transport, the injection, and the like of the catalyst are easy and the olefin polymer may be prepared more environmentally friendly and efficiently.

### MODE FOR THE INVENTION

Hereinafter, a transition metal compound according to the present invention, a catalyst composition including the same, and a method for preparing an olefin polymer using the same will be described in detail.

The singular form used in the present specification may be intended to also include a plural form, unless otherwise indicated in the context.

The term “comprise” described in the present specification is an open-ended description having a meaning equivalent to the term such as “is/are provided”, “contain”, “have”, or “is/are characterized”, and does not exclude elements, materials or processes which are not further listed.

The terms “substituent”, “radical”, “group”, “moiety”, and “fragment” in the present specification may be used interchangeably.

The term “C_{A}-C_{B}” in the present specification refers to “the number of carbons being A or more and B or less”.

The term “alkyl” used in the present specification refers to a saturated linear or branched acyclic hydrocarbon having 1 to 20 carbon atoms in which the number of carbons is not particularly defined. A representative saturated linear alkyl includes methyl, ethyl, n-propyl, n-butyl, n-pentyl, n-hexyl, n-heptyl, n-octyl, n-nonyl, and n-decyl, while saturated branched alkyl includes isopropyl, sec-butyl, isobutyl, tert-butyl, isopentyl, 2-methylhexyl, 3-methylbutyl, 2-methylpentyl, 3-methylpentyl, 4-methylpentyl, 2-methylhexyl, 3-methylhexyl, 2-methylpentyl, 3-methylpentyl, 4-methylpentyl, 2-methylhexyl, 3-methylhexyl, 4-methylhexyl, 5-methylhexyl, 2,3-dimethylbutyl, 2,3-dimethylpentyl, 2,4-dimethylpentyl, 2,3-dimethylhexyl, 2,4-dimethylhexyl, 2,5-dimethylhexyl, 2,2-dimethylpentyl, 2,2-dimethylhexyl, 3,3-dimethylpentyl, 3,3-dimethylhexyl, 4,4-dimethylhexyl, 2-ethylpentyl, 3-ethylpentyl, 2-decylhexyl, 3-ethylhexyl, 4-ethylhexyl, 2-methyl-2-ethylpentyl, 2-methyl-3-ethylpentyl, 2-methyl-4-ethylpentyl, 2-methyl-2-ethylhexyl, 2-methyl-3-ethylhexyl, 2-methyl-4-ethylhexyl, 2,2-diethylpentyl, 3,3-diethylhexyl, 2,2-diethylhexyl, and 3,3-diethylhexyl.

“Alkenyl” described in the present specification refers to a saturated linear or branched acyclic hydrocarbon containing 2 to 10, preferably 2 to 10 carbon atoms, more preferably 2 to 5 carbon atoms and at least one carbon-carbon double bond. A representative linear or branched C2-C10 alkenyl includes vinyl, allyl, 1-butenyl, 2-butenyl, isobutenyl, 1-pentenyl, 2-pentenyl, 3-methyl-1-butenyl, 2-methyl-2-butenyl, 2,3-dimethyl-2-butenyl, 1-hexenyl, 2-hexenyl, 3-hexenyl, 1-heptenyl, 2-heptenyl, 3-heptenyl, 1-octenyl, 2-octenyl, 3-octenyl, 1-nonenyl, 2-nonenyl, 3-nonenyl, 1-dicenyl, 2-dicenyl, and-3-dicenyl. Alkenyl include radicals being cis- and trans-oriented, or alternatively, having E and Z orientations.

“Alkoxy” described in the present specification refers to —O-(alkyl) including —OCH₃, —OCH₂CH₃, —O(CH₂)₂CH₃, —O(CH₂)₃CH₃, —O(CH₂)₅CH₃, and the like, in which alkyl is as defined above.

“Alkylene” and “alkenylene” described in the present specification refer to divalent organic radicals derived from “alkyl” and “alkenyl”, respectively, by removing one hydrogen, in which alkyl and alkenyl are as defined above, respectively.

The term “cycloalkyl” used in the present specification refers to a monocyclic or polycyclic saturated ring having carbon and hydrogen atoms and no carbon-carbon multiple bond. An example of the cycloalkyl group includes C3-C10 cycloalkyl, and for example, includes cyclopropyl, cyclobutyl, cyclopentyl, cyclohexyl, and cycloheptyl, but is not limited thereto. In an exemplary embodiment, the cycloalkyl group is a monocyclic or bicyclic ring.

“Aryl” described in the present specification is an organic radical derived from an aromatic hydrocarbon by removing one hydrogen, and includes a monocyclic or fused ring system containing appropriately 4 to 7, preferably 5 or 6 ring atoms in each ring and includes even a form in which a plurality of aryls are connected by a single bond. A fused ring system may include an aliphatic ring such as saturated or partially saturated rings, and necessarily includes one or more aromatic rings. In addition, the aliphatic ring may contain nitrogen, oxygen, sulfur, carbonyl, and the like in the ring. A specific example of the aryl radical includes phenyl, naphthyl, biphenyl, indenyl, fluorenyl, phenanthrenyl, anthracenyl, triphenylenyl, pyrenyl, cricenyl, naphthacenyl, 9,10-dihydroanthracenyl, and the like, but is not limited thereto.

The term “alkylaryl” in the present specification refers to an aryl radical substituted by at least one alkyl, in which “alkyl” and “aryl” are as defined above. A specific example of the alkylaryl includes tolyl and the like, but is not limited thereto.

The term “arylalkyl” in the present specification refers to an alkyl radical substituted by at least one aryl, in which “alkyl” and “aryl” are as defined above. A specific example of the arylalkyl includes benzyl and the like, but is not limited thereto.

The term “aryloxy” described in the present specification refers to an —O-aryl radical, in which “aryl” is as defined above.

A specific example of “alkylsilyl” and “arylsilyl” described in the present specification includes trimethylsilyl, triethylsilyl, t-butyldimethylsilyl, propyldimethylsilyl, triphenylsilyl, diphenylsilyl, phenylsilyl, and the like, but is not limited thereto.

The term “diene” used in the present specification means that there are two double bonds in bonds between carbons, and may be a compound selected from s-trans-1,3-butadiene, s-cis-1,3-butadiene, 2,4-pentadiene, cyclopentadiene, 1,3-cyclohexadiene, 1,4-cyclohexadiene, and bicyclo[2.2.1]hepta-1,3-diene, or a derivative thereof. For example, it may be s-trans-n4-1,4-diphenyl-1,3-butadiene; s-trans-n4-3-methyl-1,3-pentadiene; s-trans-n4-1,4-dibenzyl-1,3-butadiene; s-trans-n4-1,3-pentadiene; s-trans-n4-2,4-hexadiene; s-trans-n4-1,4-ditolyl-1,3-butadiene; s-trans-n4-1,4-bis (trimethylsilyl)-1,3-butadiene; s-cis-n4-1,4-diphenyl-1,3-butadiene; s-cis-n4-3-methyl-1,3-pentadiene; s-cis-n4-1,4-dibenzyl-1,3-butadiene; s-cis-n4-1,3-pentadiene; s-cis-n4-2,4˜hexadiene; s-cis-n4-1,4-ditolyl-1,3-butadiene; or s-cis-n4-1,4-bis (trimethylsilyl)-1,3-butadiene, but is not limited thereto.

The term “olefin polymer” used herein refers to a polymer prepared using olefins within a range which may be recognized by a person skilled in the art. Specifically, the olefin polymer includes both a homopolymer of olefin or a copolymer of olefins, and refers to a homopolymer of olefin or a copolymer of olefin and α-olefin.

The present invention provides a transition metal compound represented by the following Chemical Formula 1, which may be very usefully used in olefin polymerization because solubility is improved and thermal stability is improved by introducing a conjugated or non-conjugated diene functional group:

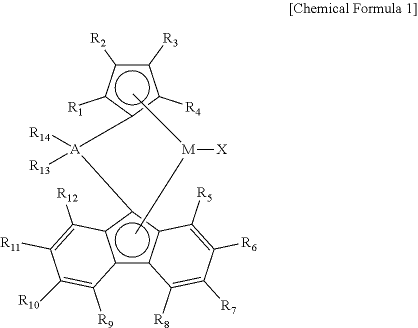

wherein
M is a Group 4 transition metal in the periodic table;
A is carbon or silicon;
R₁ to R₄ are independently of one another hydrogen or C₁-C₂₀alkyl;
R₅ to R₁₂ are independently of one another hydrogen, C₁-C₂₀alkyl, C₁-C₂₀alkoxy, C₃-₂₀cycloalkyl, C₆-C₂₀aryl, C₆-C₂₀arylC₁-C₂₀alkyl, C₁-C₂₀alkylC₆-C₂₀aryl, triC₁-C₂₀ alkylsilyl, or triC₆-C₂₀arylsilyl, or each of the R₅ to R₁₂ may be linked to an adjacent substituent via C₃-C₁₂alkylene or C₃-C₁₂alkenylene with or without a fused ring to form an alicyclic ring or form a monocyclic or polycyclic aromatic ring;
R₁₃ and R₁₄ are independently of each other C₆-C₂₀aryl;
X is conjugated or non-conjugated C₄-C₂₀diene;
the diene may be further substituted by one or two or more substituents selected from the group consisting of C₁-C₂₀alkyl, C₃-C₂₀cycloalkyl, C₆-C₂₀aryl, C₆-C₂₀arylC₁-C₂₀ alkyl, C₁-C₂₀alkylC₆-C₂₀aryl, C₁-C₂₀alkoxy, C₆-C₂₀aryloxy, triC₁-C₂₀alkylsilyl, and triC₆-C₂₀arylsilyl; and
the diene forms a π-complex with a central metal M.

The transition metal compound according to an exemplary embodiment of the present invention is represented by Chemical Formula 1, and solubility in a non-aromatic hydrocarbon solvent is significantly improved by introducing a conjugated or non-conjugated diene having 4 to 20 carbon atoms as X in Chemical Formula 1, and an olefin polymer may be prepared environmentally friendly with high catalytic activity by a simple process.

Specifically, the transition metal compound of the present invention, which is an ANSA-type catalyst of the present invention, may increase the solubility in a non-aromatic hydrocarbon solvent and maintain catalytic activity by introducing a diene functional group at a specific position, and at the same time, an olefin polymer may be easily prepared by a solution process.

Preferably, in Chemical Formula 1 according to an exemplary embodiment of the present invention, M may be a Group 4 transition metal in the periodic table; A may be carbon or silicon; R₁ to R₄ may be independently of one another hydrogen or C₁-C₁₀ alkyl; R₅ to R₁₂ may be independently of one another hydrogen, C₁-C₁₀alkyl, C₁-C₁₀ alkoxy, C₃-C₁₀cycloalkyl, C₆-C₁₀aryl, C₆-C₁₀arylC₁-C₁₀alkyl, C₁-C₁₀alkylC₆-C₁₀aryl, triC₁-C₁₀alkylsilyl, or triC₆-C₁₀arylsilyl, or each of the R₅ to R₁₂ may be linked to an adjacent substituent via C₃-C₁₂alkylene or C₃-C₁₂alkenylene with or without a fused ring to form an alicyclic ring or form a monocyclic or polycyclic aromatic ring; R₁₃ and R₁₄ may be independently of each other C₆-C₁₀aryl; X may be conjugated or non-conjugated C₄-C₁₀diene; the diene may be further substituted by one or two or more substituents selected from the group consisting of C₁-C₁₀alkyl, C₃-C₁₀cycloalkyl, C₆-C₁₀ aryl, C₆-C₁₀arylC₁-C₁₀alkyl, C₁-C₁₀alkylC₆-C₁₀aryl, C₁-C₁₀alkoxy, C₆-C₁₀aryloxy, triC₁-C₁₀alkylsilyl, and triC₆-C₁₀arylsilyl; and the diene may form a π-complex with a central metal M.

More preferably, in Chemical Formula 1 according to an exemplary embodiment of the present invention, M may be Ti, Zr, or Hf; A may be carbon or silicon; R₁ to R₄ may be independently of one another hydrogen or C₁-C₄alkyl; R₅ to R₁₂ may be independently of one another hydrogen, C₁-C₄alkyl, or C₁-C₄alkoxy; R₁₃ and R₁₄ may be independently of each other C₆-C₁₀aryl; X may be conjugated or non-conjugated C₄-C₇ diene; the diene may be further substituted by one or two or more substituents selected from the group consisting of C₁-C₁₀alkyl, C₃-C₁₀cycloalkyl, C₆-C₁₀aryl, C₆-C₁₀arylC₁-C₁₀alkyl, C₁-C₁₀alkylC₆-C₁₀aryl, C₁-C₁₀alkoxy, C₆-C₁₀aryloxy, triC₁-C₁₀alkylsilyl, and triC₆-C₁₀arylsilyl; and the diene may form a π-complex with a central metal M.

In an exemplary embodiment of the present invention, the transition metal compound may be represented by the following Chemical Formula 2:

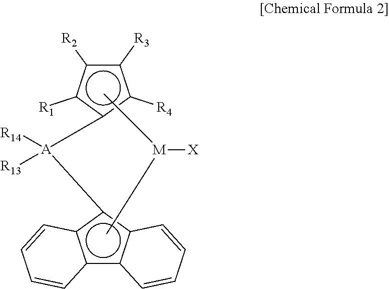

wherein
M is Ti, Zr, or Hf;
A is carbon or silicon;
R₁ to R₄ are independently of one another hydrogen or C₁-C₄alkyl;
R₁₃ and R₁₄ are independently of each other C₆-C₁₀aryl;
X is

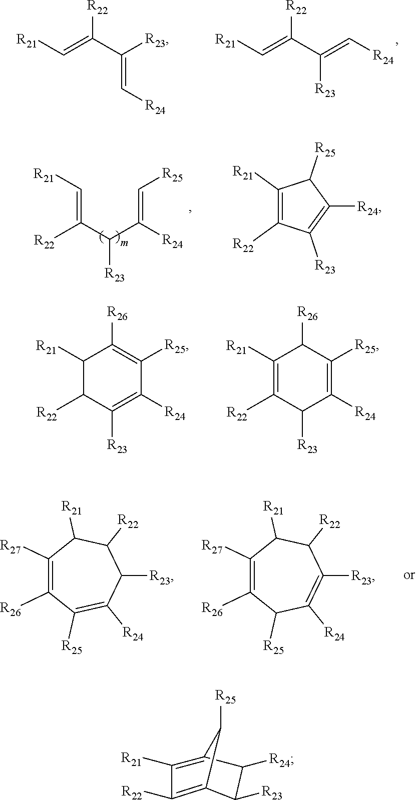

R₂₁ to R₂₇ are independently of one another hydrogen, C₁-C₁₀alkyl, C₃-C₁₀cycloalkyl, C₆-C₁₀aryl, C₆-C₁₀arylC₁-C₁₀alkyl, C₁-C₁₀alkylC₆-C₁₀aryl, C₁-C₁₀alkoxy, C₆-C₁₀aryloxy, triC₁-C₁₀alkylsilyl, or triC₆-C₁₀arylsilyl;
m is an integer of 1 to 3; and
X forms a π-complex with a central metal M.

Specifically, in an exemplary embodiment of the present invention, the transition metal compound may be selected from the following compounds:

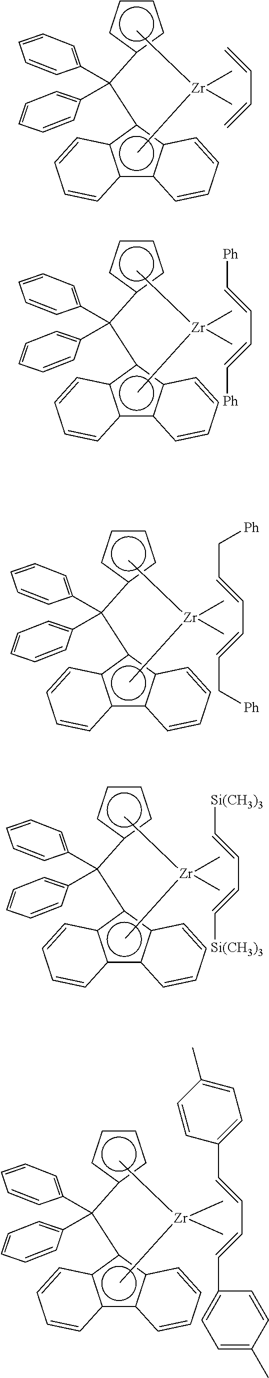

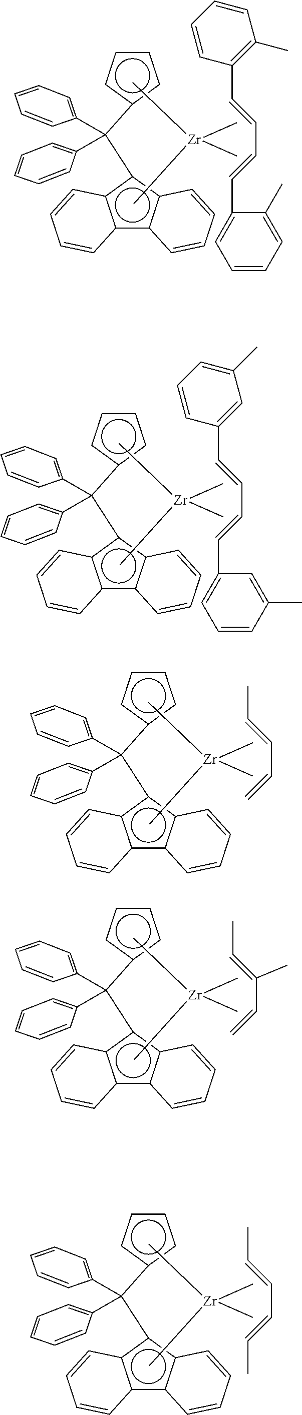

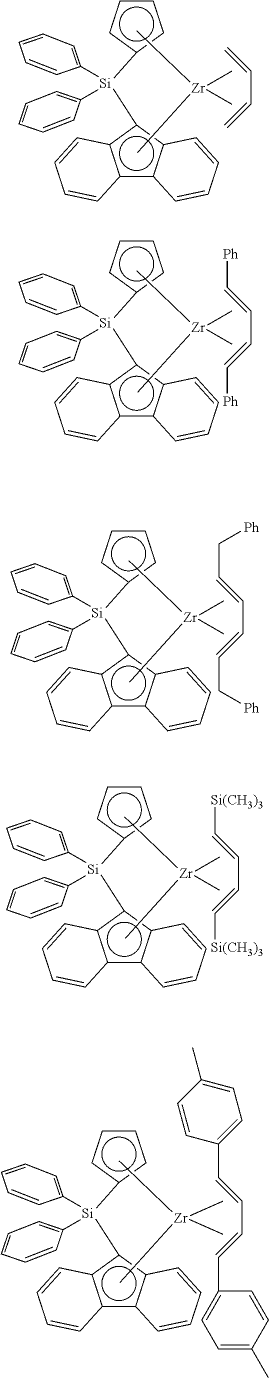

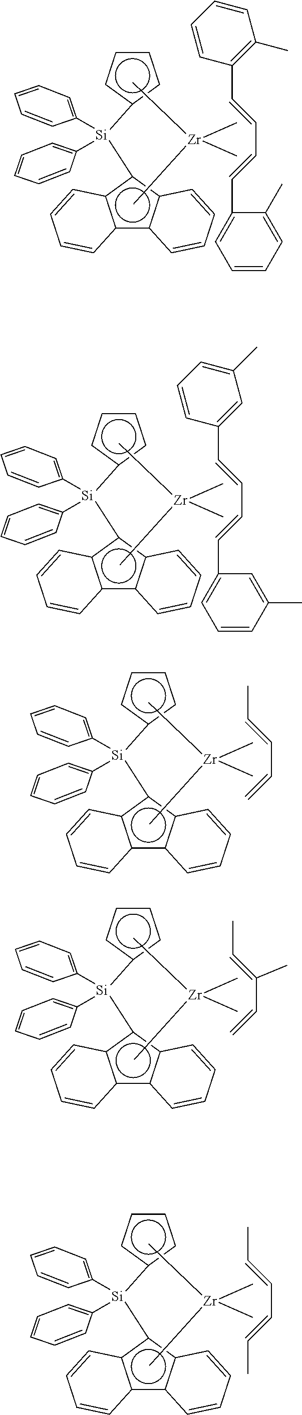

The transition metal compound according to an exemplary embodiment of the present invention may have a solubility in methylcyclohexane of 5 wt % or more, preferably 5.5 to 50 wt % at 25° C.

In addition, the present invention provides a transition metal catalyst composition for preparing an ethylene homopolymer or a copolymer of ethylene and α-olefin including the transition metal compound according to the present invention, and the transition metal catalyst composition includes: a transition metal compound represented by the following Chemical Formula 1; and a cocatalyst:

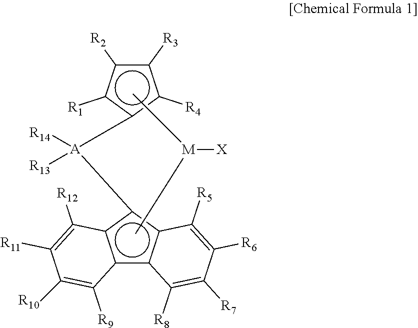

wherein
M is a Group 4 transition metal in the periodic table;
A is carbon or silicon;
R₁ to R₄ are independently of one another hydrogen or C₁-C₂₀alkyl;
R₅ to R₁₂ are independently of one another hydrogen, C₁-C₂₀alkyl, C₁-C₂₀alkoxy, C₃-C₂₀cycloalkyl, C₆-C₂₀aryl, C₆-C₂₀arylC₁-C₂₀alkyl, C₁-C₂₀alkylC₆-C₂₀aryl, triC₁-C₂₀ alkylsilyl, or triC₆-C₂₀arylsilyl, or each of the R₅ to R₁₂ may be linked to an adjacent substituent via C₃-C₁₂alkylene or C₃-C₁₂alkenylene with or without a fused ring to form an alicyclic ring or form a monocyclic or polycyclic aromatic ring;
R₁₃ and R₁₄ are independently of each other C₆-C₂₀aryl;
X is conjugated or non-conjugated C₄-C₂₀diene;
the diene may be further substituted by one or two or more substituents selected from the group consisting of C₁-C₂₀alkyl, C₃-C₂₀cycloalkyl, C₆-C₂₀aryl, C₆-C₂₀arylC₁-C₂₀ alkyl, C₁-C₂₀alkylC₆-C₂₀aryl, C₁-C₂₀alkoxy, C₆-C₂₀aryloxy, triC₁-C₂₀alkylsilyl, and triC₆-C₂₀arylsilyl; and
the diene forms a π-complex with a central metal M.

The cocatalyst included in the transition metal catalyst composition may be an aluminum compound cocatalyst, a boron compound cocatalyst, or a mixture thereof.

In addition, the present invention provides a method for preparing an olefin polymer using the transition metal compound according to the present invention.

The method for preparing an olefin polymer includes: obtaining an olefin polymer by solution polymerization of one or two or more monomers selected from ethylene and α-olefins in the presence of a transition metal compound represented by Chemical Formula 1, a cocatalyst, and a non-aromatic hydrocarbon solvent.

The non-aromatic hydrocarbon solvent may be one or two or more selected from the group consisting of methylcyclohexane, cyclohexane, n-heptane, n-hexane, n-butane, isobutane, n-pentane, n-octane, isooctane, nonane, decane, and dodecane, and a solubility of the transition metal compound according to an exemplary embodiment of the present invention in the non-aromatic hydrocarbon solvent may be 5 wt % or more, preferably 5.5 to 50 wt % at 25° C.

Preferably, in the method for preparing an olefin polymer according to an exemplary embodiment of the present invention, the cocatalyst may be an aluminum compound cocatalyst, a boron compound cocatalyst, or a mixture thereof, and a mole ratio of transition metal compound: cocatalyst may be 1:0.5 to 10,000.

Specifically, the boron compound cocatalyst may be one or a mixture of two or more selected from compounds represented by the following Chemical Formulae 11 to 14:

BR³¹₃ [Chemical Formula 11]

[R³²]⁺[BR³¹₄]⁻ [Chemical Formula 12]

[R³³ₚZH]⁺[BR³¹₄]⁻ [Chemical Formula 13]

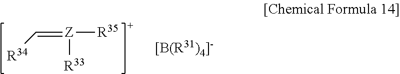

wherein
B is a boron atom;
R³¹ is phenyl, and the phenyl may be further substituted by 3 to 5 substituents selected from the group consisting of a fluorine atom, C₁-C₂₀alkyl, C₁-C₂₀alkyl substituted by a fluorine atom, C₁-C₂₀alkoxy, and C₁-C₂₀alkoxy substituted by a fluorine atom;
R³² is a C₅-C₇aromatic radical, a C₁-C₂₀alkylC₆-C₂₀aryl radical, or a C₆-C₂₀arylC₁-C₂₀ alkyl radical, for example, a triphenylmethylium radical;
Z is nitrogen or a phosphorous atom;
R³³ is a C₁-C₂₀alkyl radical or an anilinium radical substituted by two C₁-C₁₀alkyls with a nitrogen atom;
R³⁴ is C₅-C₂₀alkyl;
R³⁵ is C₅-C₂₀aryl or C₁-C₂₀alkylC₆-C₂₀aryl; and
p is an integer of 2 or 3.

The boron compound cocatalyst may be, for example, one or two or more selected from tris(pentafluorophenyl)borane, tris(2,3,5,6-tetrafluorophenyl)borane, tris(2,3,4,5-tetrafluorophenyl)borane, tris(3,4,5-trifluorophenyl)borane, tris(2,3,4-trifluorophenyl)borane, bis(pentafluorophenyl)(phenyl)borane, and the like.

The boron compound cocatalyst may be one or two or more boron compounds having a borate anion selected from the group consisting of tetrakis(pentafluorophenyl)borate, tetrakis(2,3,5,6-tetrafluorophenyl)borate, tetrakis(2,3,4,5-tetrafluorophenyl)borate, tetrakis(3,4,5-trifluorophenyl)borate, tetrakis(2,2,4-trifluorophenyl)borate, tris(pentafluorophenyl)(phenyl)borate, and tetrakis(3,5-bistrifluoromethylphenyl)borate.

The boron compound cocatalyst may be one or two or more boron compounds having a cation selected from the group consisting of triphenylmethylium, triethylammonium, tripropylammonium, tri(n-butyl)ammonium, N,N-dimethylanilinium, N,N-diethylanilinium, N,N-2,4,6-pentamethylanilinium, diisopropylammonium, dicyclohexylammonium, triphenylphosphonium, tri(methylphenyl)phosphonium, and tri(dimethylphenyl)phosphonium.

Specifically, the boron compound cocatalyst may be one or two or more boron compounds having a cation selected from the group consisting of triphenylmethylium, triethylammonium, tripropylammonium, tri(n-butyl)ammonium, N,N-dimethylanilinium, N,N-diethylanilinium, N,N-2,4,6-pentamethylanilinium, diisopropylammonium, dicyclohexylammonium, triphenylphosphonium, tri(methylphenyl)phosphonium, and tri(dimethylphenyl)phosphonium and a borate anion selected from the group consisting of tetrakis(pentafluorophenyl)borate, tetrakis(2,3,5,6-tetrafluorophenyl)borate, tetrakis(2,3,4,5-tetrafluorophenyl)borate, tetrakis(3,4,5-trifluorophenyl)borate, tetrakis(2,2,4-trifluorophenyl)borate, tris(pentafluorophenyl)(phenyl)borate, and tetrakis(3,5-bistrifluoromethylphenyl)borate.

More specifically, the boron compound cocatalyst may be one or two or more selected from the group consisting of triphenylmethylium tetrakis(pentafluorophenyl)borate, triphenylmethylium tetrakis(3,5-bistrifluoromethylphenyl) borate, triethylammonium tetrakis(pentafluorophenyl)borate, tripropylammonium tetrakis(pentafluorophenyl)borate, tri(n-butyl)ammonium tetrakis(pentafluorophenyl)borate, tri(n-butyl)ammonium tetrakis(3,5-bistrifluoromethylphenyl)borate, N,N-dimethylanilinium tetrakis(pentafluorophenyl)borate, N,N-diethylanilinium tetrakis(pentafluorophenyl)borate, N,N-2,4,6-pentamethylanilinium tetrakis(pentafluorophenyl)borate, N,N-dimethylanilinium tetrakis(3,5-bistrifluoromethylphenyl)borate, diisopropylammonium tetrakis(pentafluorophenyl)borate, dicyclohexylammonium tetrakis(pentafluorophenyl)borate, triphenylphosphonium tetrakis(pentafluorophenyl)borate, tri(methylphenyl)phosphonium tetrakis(pentafluorophenyl)borate, and tri(dimethylphenyl)phosphonium tetrakis(pentafluorophenyl)borate, and more preferably, one or two or more selected from the group consisting of triphenylmethylinium tetrakis(pentafluorophenyl)borate, N,N-dimethylanilinium tetrakis(pentafluorophenyl)borate, and tris (pentafluorophenyl) borane.

Specifically, the aluminum compound cocatalyst may be one or a mixture of two or more selected from an aluminoxane compound of Chemical Formula 15 or 16, an organic aluminum compound of Chemical Formula 17, or an organic aluminum alkyl oxide or an organic aluminum aryl oxide compound of Chemical Formula 18 or 19:

—(Al(R⁴¹)—O)ᵣ— [Chemical Formula 15]

(R⁴²)₂Al—(—O(R⁴²)—)ₛ—O—Al(R⁴²)₂ [Chemical Formula 16]

(R⁴³)ₜAl(E)₃₋ₜ [Chemical Formula 17]

(R⁴⁴)₂AlOR⁴⁵ [Chemical Formula 18]

R⁴⁴Al(OR⁴⁵)₂ [Chemical Formula 19]
wherein
R⁴¹ and R⁴² are independently of each other C₁-C₂₀alkyl;
r and s are independently of each other an integer of 5 to 20;
R⁴³ and R⁴⁴ are independently of each other C₁-C₂₀alkyl;
E is hydrogen or halogen;
t is an integer of 1 to 3; and
R⁴⁵ is C₁-C₂₀alkyl or C₆-C₃₀aryl.

The aluminoxane compound may include, for example, methylaluminoxane,

modified methylaluminoxane, tetraisobutylaluminoxane, and the like; and an example of an organic aluminum compound may include: trialkylaluminum including trimethylaluminum, triethylaluminum, tripropylaluminum, triisobutylaluminum, and trihexylaluminum; dialkylaluminum chloride including dimethylaluminum chloride, diethylaluminum chloride, dipropylaluminum chloride, diisobutylaluminum chloride, and dihexylaluminum chloride; alkylaluminum dichloride including methylaluminum dichloride, ethylaluminum dichloride, propylaluminum dichloride, isobutylaluminum dichloride, and hexylaluminum dichloride; dialkylaluminum hydride including dimethylaluminum hydride, diethylaluminum hydride, dipropylaluminum hydride, diisobutylaluminum hydride, and dihexylaluminum hydride; alkylalkoxyaluminum including methyldimethoxyaluminum, dimethylmethoxyaluminum, ethyldiethoxyaluminum, diethylethoxyaluminum, isobutyldibutoxyaluminum, diisobutylbutoxyaluminum, hexyldimethoxyaluminum, dihexylmethoxyaluminum, and dioctylmethoxyaluminum.

Preferably, it may be methylaluminoxane, modified methylaluminoxane, tetraisobutylaluminoxane, trialkylaluminum, triethylaluminum, triisobutylaluminum, or a mixture thereof, and more preferably, it may be methylaluminoxane, modified methylaluminoxane, or trialkylaluminum, specifically triethylaluminum and triisobutylaluminum.

In the catalyst composition according to an exemplary embodiment of the present invention, when the aluminum compound is used as a cocatalyst, a preferred range of a ratio between the transition metal compound of the present invention and the cocatalyst may be 1:10 to 1,000, specifically 1:25 to 500, as a mole ratio of transition metal (M): aluminum atom (Al).

In the catalyst composition according to an exemplary embodiment of the present invention, when both the aluminum compound and the boron compound are used as a cocatalyst, a preferred range of a ratio between the transition metal compound of the present invention and the cocatalyst may be 1:0.1 to 100:10 to 1,000, specifically 1:0.5 to 5:25 to 500, as a mole ratio of transition metal (M):boron atom (B):aluminum atom (Al). Within the range of the ratio between the transition metal compound of the present invention and the cocatalyst, excellent catalytic activity for preparing an olefin polymer is shown, and the range of ratio varies depending on the purity of the reaction.

As another aspect according to an exemplary embodiment of the present invention, a method for preparing an olefin polymer using the transition metal compound may be carried out by contacting the transition metal compound, a cocatalyst, and ethylene or, if necessary, a vinyl-based comonomer in the presence of a non-aromatic hydrocarbon solvent.

Here, the transition metal compound and the cocatalyst components may be added to a reactor separately, or each component may be mixed previously and then added to a reactor, and mixing conditions such as an addition order, temperature or concentration are not separately limited.

A preferred organic solvent which may be used in the preparation method may be a non-aromatic hydrocarbon solvent, specifically a non-aromatic hydrocarbon having 3 to 20 carbon atoms, and for example, may be butane, isobutane, pentane, hexane, heptane, octane, isooctane, nonane, decane, dodecane, cyclohexane, methylcyclohexane, and the like.

Specifically, when a copolymer of ethylene and α-olefin is prepared, α-olefin having 3 to 18 carbon atoms as a comonomer may be used with ethylene, and preferably, may be one or two or more selected from the group consisting of propylene, 1-butene, 1-pentene, 4-methyl-1-pentene, 1-hexene, 1-octene, 1-decene, 1-dodecene, 1-hexadecene, and 1-octadecene. More specifically, 1-butene, 1-hexene, 1-octene, or 1-decene may be copolymerized with ethylene, and a preferred pressure of ethylene may be 1 to 1,000 atm, more preferably 10 to 150 atm.

In addition, in the method for preparing olefin according to an exemplary embodiment of the present invention, the solution polymerization may be performed at 100 to 220° C., preferably 100 to 200° C., and more preferably 100 to 150° C.

The copolymer prepared according to the method of the present invention may contain 50 to 99 wt %, specifically 60 to 99 wt % of ethylene.

In the method for preparing an olefin polymer according to an exemplary embodiment of the present invention, linear low-density polyethylene, LLDPE, which is prepared using an α-olefin having 4 to 10 carbon atoms as a comonomer, has a density range of 0.940 g/cc or less, and the preparation may be extended to ultralow-density polyethylene having a density range of 0.900 g/cc or less, VLDPE, ULDPE, or even an olefin elastomer. In addition, in the preparation of an ethylene copolymer according to the present invention, hydrogen may be used as a molecular weight regulator for adjusting a molecular weight, and the prepared copolymer has a weight average molecular weight (Mw) of 80,000 to 500,000 g/mol.

An ethylene-propylene-diene copolymer as a specific example of the olefin-diene copolymer prepared by the catalyst composition according to an exemplary embodiment of the present invention may have an ethylene content of 30 to 80 wt %, a propylene content of 20 to 70 wt %, and a diene content of 0 to 15 wt %. A diene monomer which may be used in the present invention has two or more double bonds, and may be one or two or more selected from the group consisting of 1,4-hexadiene, 1,5-hexadiene, 1,5-heptadiene, 1,6-heptadiene, 1,6-octadiene, 1,7-octadiene, 1,7-nonadiene, 1,8-nonadiene, 1,8-decadiene, 1,9-decadiene, 1,12-tetradecadiene, 1,13-tetradecadiene, 3-methyl-1,4-hexadiene, 3-methyl-1,5-hexadiene, 3-ethyl-1,4-hexadiene, 3-ethyl-1,5-hexadiene, 3,3-dimethyl-1,4-hexadiene, 3,3-dimethyl-1,5-hexadiene, 5-vinyl-2-norbornene, 2,5-norbornadiene, 7-methyl-2,5-norbornadiene, 7-ethyl-2,5-norbornadiene, 7-propyl-2,5-norbornadiene, 7-butyl-2,5-norbornadiene, 7-phenyl-2,5-norbornadiene, 7-hexyl-2,5-norbornadiene, 7,7-dimethyl-2,5-norbornadiene, 7-methyl-7-ethyl-2,5-norbornadiene, 7-chloro-2,5-norbornadiene, 7-bromo-2,5-norbornadiene, 7-fluoro-2,5-norbornadiene, 7,7-dichloro-2,5-norbornadiene, 1-methyl-2,5-norbornadiene, 1-ethyl-2,5-norbornadiene, 1-propyl-2,5-norbornadiene, 1-butyl-2,5-norbornadiene, 1-chloro-2,5-norbornadiene, 1-bromo-2,5-norbornadiene, 5-isopropyl-2-norbornene, 1,4-cyclohexadiene, bicyclo[2,2,1]hepta-2,5-diene, 5-ethylidene-2-norbornene, 5-methylene-2-norbornene, bicyclo[2,2,2]octa-2,5-diene, 4-vinyl-1-cyclohexene, bicyclo[2,2,2]octa-2,6-diene, 1,7,7-trimethylbicyclo[2,2,1]hepta-2,5-diene, dicyclopentadiene, phenyltetrahydroindene, 5-phyenylbicyclo[2,2,1]hept-2-ene, 1,5-cyclooctadiene, 1,4-diphenylbenzene, butadiene, isoprene, 2,3-dimethyl-1,3-butadiene, 1,3-butadiene, 4-methyl-1,3-pentadiene, 1,3-pentadiene, 3-methyl-1,3-pentadiene, 2,4-dimethyl-1,3-pentadiene, and 3-ethyl-1,3-pentadiene, preferably 5-ethylidene-2-norbornene, dicyclopentadiene, or a mixture thereof. The diene monomer may be selected depending on the processing properties of an ethylene-propylene-diene copolymer.

The ethylene-olefin-diene copolymer prepared according to an exemplary embodiment of the present invention may have an ethylene content of 30 to 80 wt %, an olefin content of 20 to 70 wt %, and a diene content of 0 to 15 wt %, based on the total weight.

Generally, in the case of preparing the ethylene-propylene-diene copolymer, when a propylene content is increased, the molecular weight of the copolymer is decreased, however, in the case of preparing the ethylene-propylene-diene copolymer according to an exemplary embodiment of the present invention, even when a propylene content is increased up to 50 wt %, a product having a relatively high molecular weight may be prepared without a decrease of the molecular weight.

Since the catalyst composition presented in the present invention is present in a homogencous form in a polymerization reactor, it is preferred to apply to a solution polymerization process which is carried out at a temperature equal to or more than a melting point of the polymer. However, as disclosed in U.S. Pat. No. 4,752,597, the catalyst composition may also be used in a slurry polymerization or gas phase polymerization process in the form of a heterogeneous catalyst composition obtained by supporting the transition metal compound and the cocatalyst on a porous metal oxide support.

Hereinafter, the novel transition metal compound according to the present invention, the catalyst composition including the same, and a method for preparing an olefin polymer using the same will be described in more detail, through specific examples.

Unless otherwise stated, all experiments of synthesizing the transition metal compound were carried out using a standard Schlenk or glove box technology under a nitrogen atmosphere, and the organic solvents used in the reaction were subjected to reflux over sodium metal and benzophenone to thereby remove moisture, and then distilled immediately before use. The ¹H NMR analysis of the synthesized transition metal compound was carried out using Bruker 400 or 500 MHz at room temperature.

Normal heptane, which is a polymerization solvent, was used after being passed through a tube filled with a 5 Å molecular sieve and activated alumina and bubbling with high-purity nitrogen to sufficiently remove moisture, oxygen and other catalyst poison substances. The polymerized polymer was analyzed by the method described below:

### 1. Melt Flow Index, MI

The melt flow index was measured at 190° C. under a load of 2.16 kg using an ASTM

D1238 analysis method.

### 2. Density

The density was measured by an ASTM D792 analysis method.

### 3. Molecular Weight and Molecular Weight Distribution

The molecular weight was measured by gel chromatography formed of a three-stage mixed column.

The solvent used herein was 1,2,4-trichlorobenzene, and the measuring temperature

was 120° C.

### [Example 1] Synthesis of Compound 1

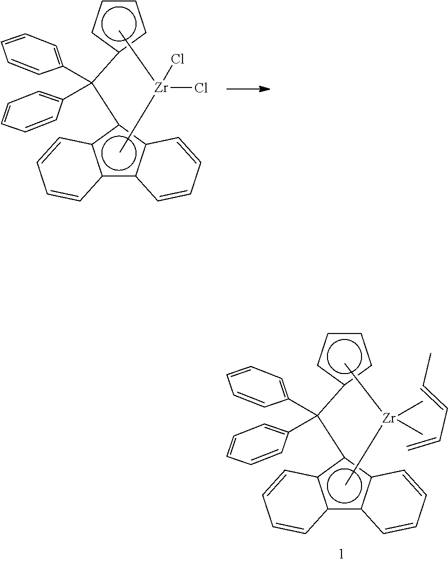

9-Fluorenyl-1-diphenylmethylcyclopentadienyl zirconium dichloride (product of S-PCI, 10.0 g, 18.0 mmol) was dissolved in 100 mL of toluene in a 250 mL round flask under a nitrogen atmosphere. After the temperature was lowered to −15° C., 1,3-pentadiene (cis-, trans-mixture; 3.7 g, 54.0 mmol) and 1.6 M butyllithium (22.5 mL, 35.9 mmol) were slowly injected, the temperature was raised to room temperature, and stirring was performed for 5 hours. The solvent was removed under vacuum, the concentrate was dissolved in 200 mL of methylcyclohexane, and the solution was filtered through a filter filled with dried celite to remove a solid content. All solvents in the filtrate was removed to obtain Compound 1 in red (9.98 g, yield: 95.0%).

¹H NMR (500 MHZ, Chloroform-d): δ=8.23; (d, 2H), 7.88; (dd, 4H), 7.45; (m, 4H), 7.31; (m, 4H), 7.01; (m, 2H), 6.42; (m, 4H), 5.64; (m, 2H), 4.01; (dd, J=9.3, 7.3 Hz, 1H), 3.86; (ddd, J=13.2, 9.3, 8.9 Hz, 1H), 2.98; (dd, J=8.9, 8 Hz, 1H), 2.13; (m, 1H), 1.90; (d, J=5.5 Hz, 3H), 1.76; (dd, J=13.2, 7.3 Hz, 1H)

### Comparative Example 1

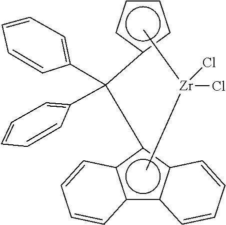

The compound of Comparative Example 1 was purchased from S-PCI and used.

### Comparative Example 2

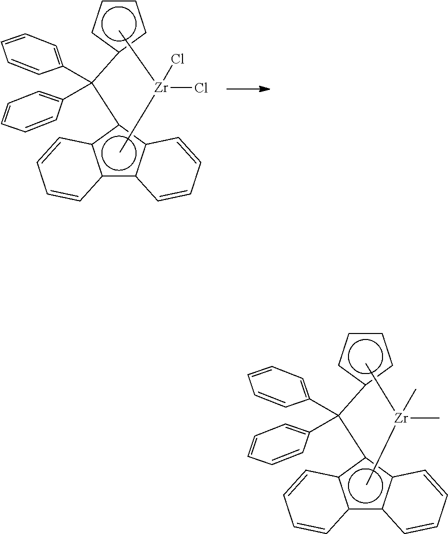

9-Fluorenyl-1-diphenylmethylcyclopentadienyl zirconium dichloride (product of S-PCI, 10.0 g, 18.0 mmol) was dissolved in 100 mL of toluene in a 250 mL round flask under a nitrogen atmosphere. After the temperature was lowered to −15° C., 1.5 M methyllithium (24.0 mL, 35.9 mmol) was slowly injected, the temperature was raised to room temperature, stirring was performed for 3 hours, and the solution was filtered through a filter filled with dried celite to remove a solid content. After the filtration, all solvents in the filtrate were removed to obtain a Compound of Comparative Example 2 in yellow (8.5 g, yield: 91.4%).

¹H NMR (500 MHZ, Chloroform-d): δ=8.20; (d, 2H), 7.85; (dd, 4H), 7.41; (m, 4H), 7.28; (m, 4H), 6.89; (m, 2H), 6.28; (m, 4H), 5.54; (m, 2H), −1.69; (s, 6H).

### [Experimental Example 1] Measurement of Solubility of Prepared Transition Metal Compound

1 g of the transition metal compound was dissolved in 4 g of each solvent described in the following table at 25° C. under a nitrogen atmosphere to make a saturated solution, and then a solid was removed by a 0.45 μm filter. After the solvent was all removed, the weight of the remaining catalyst was measured, and the solubility of the catalyst was calculated therefrom and is shown in the following Table 1:

TABLE 1

| Transition metal | Solubility (wt %) | Solubility (wt %) in |
|---|---|---|
| compound | in toluene | methyl-cyclohexane |
| Example 1 | >30 | 28.6 |
| Comparative Example 1 | 0.3 | Insoluble |
| Comparative Example 2 | 1.1 | Insoluble |

As shown in Table 1, it was found that the transition metal compound prepared in Example 1 of the present invention had a very high solubility in a hydrocarbon solvent, as compared with Comparative Examples 1 and 2, and in particular, showed a surprisingly improved solubility in a non-aromatic hydrocarbon solvent.

### [Example 2] Copolymerization of Ethylene and 1-octene by Continuous Solution Polymerization Process

Copolymerization of ethylene and 1-octene was performed in a continuous polymerization reactor equipped with a mechanical stirrer, which allows temperature adjustment.

The transition metal compound of Example 1 in the amount described in the following Table 2 was used as a catalyst, normal heptane was used as the solvent, and modified methylaluminoxane (20 wt %, Nouryon) was used as a cocatalyst. The catalyst was dissolved in toluene at a concentration of 0.2 g/L, respectively and injected, and 1-octene was used as a comonomer to perform polymerization. The conversion rate of the reactor was able to be assumed by the reaction conditions and the temperature gradient in the reactor when polymerization was carried out with one polymer under each reaction condition. A molecular weight was controlled by function of a reactor temperature and a 1-octene content in the case of a single active site catalyst, and the conditions and results thereof are shown in the following Table 2.

### Comparative Example 3

The process was performed in the same manner as in Example 2, except that the transition metal compound of Comparative Example 2 was used instead of the transition metal compound of Example 1 as a catalyst.

TABLE 2

| | | | Comparative |
|---|---|---|---|
| | | Example 2 | Example 3 |
| Polymerization | Transition metal compound | Example 1 | Comparative |
| conditions | | | Example 2 |
| | Total solution flow rate | 5 | 5 |
| | (kg/h) | | |
| | Ethylene input amount (wt %) | 8 | 8 |
| | Input molar ratio of 1-octene | 2.3 | 2.3 |
| | and ethylene (1-C8/C2) | | |
| | Zr input amount (μmol/kg) | 5.0 | 6.0 |
| | Al/Zr mole ratio | 200 | 200 |
| | Reaction temperature (° C.) | 120 | 120 |
| Polymerization | C2 conversion rate (%) | 85 | 82 |
| results | MI | 2.05 | 2.35 |
| | Density (g/mL) | 0.8699 | 0.8685 |

Zr: refers to Zr in the catalyst.
Al: refers to Al in cocatalyst modified methyl aluminoxane (20 wt %, Nouryon).

As shown in Table 2, in Example 2 using the transition metal compound of the present invention as a catalyst, excellent activity was maintained in spite of a decreased catalyst amount used as compared with Comparative Example 3 using the transition metal compound of Comparative Example 2, and it was found therefrom that the catalytic activity was significantly improved as compared with a conventional catalyst.

The transition metal compound according to an exemplary embodiment of the present invention has significantly increased solubility in a non-aromatic hydrocarbon solvent by introducing a diene functional group to a specific position, whereby the activity of a catalyst which may produce a polymer having excellent physical properties in spite of a decreased catalyst amount used is maintained and improved, and also an olefin polymer may be easily prepared by a solution process, and thus, an economic saving effect may be shown in an industrial process by using the transition metal compound.

1. A transition metal compound represented by the following Chemical Formula 1: 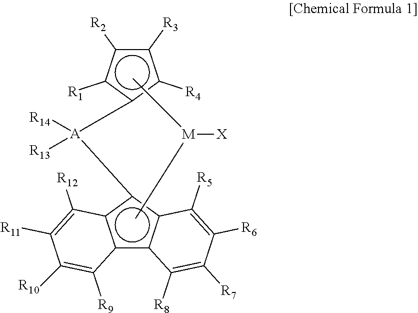
wherein
M is a Group 4 transition metal in the periodic table;
A is carbon or silicon;
R₁ to R₄ are independently of one another hydrogen or C₁-C₂₀alkyl;
R₅ to R₁₂ are independently of one another hydrogen, C₁-C₂₀alkyl, C₁-C₂₀alkoxy, C₃-C₂₀cycloalkyl, C₆-C₂₀aryl, C₆-C₂₀arylC₁-C₂₀alkyl, C₁-C₂₀ alkylC₆-C₂₀aryl, triC₁-C₂₀alkylsilyl, or triC₆-C₂₀arylsilyl, or each of the R₅ to R₁₂ may be linked to an adjacent substituent via C₃-C₁₂alkylene or C₃-C₁₂alkenylene with or without a fused ring to form an alicyclic ring or form a monocyclic or polycyclic aromatic ring;
R₁₃ and R₁₄ are independently of each other C₆-C₂₀aryl;
X is conjugated or non-conjugated C₄-C₂₀diene;
the diene may be further substituted by one or two or more substituents selected from the group consisting of C₁-C₂₀alkyl, C₃-C₂₀cycloalkyl, C₆-C₂₀aryl, C₆-C₂₀arylC₁-C₂₀alkyl, C₁-C₂₀alkylC₆-C₂₀aryl, C₁-C₂₀alkoxy, C₆-C₂₀aryloxy, triC₁-C₂₀alkylsilyl, and triC₆-C₂₀arylsilyl; and
the diene forms a π-complex with a central metal M.

2. The transition metal compound of claim 1, wherein in Chemical Formula 1,
M is a Group 4 transition metal in the periodic table;
A is carbon or silicon;
R₁ to R₄ are independently of one another hydrogen or C₁-C₁₀alkyl;
R₅ to R₁₂ are independently of one another hydrogen, C₁-C₁₀alkyl, C₁-C₁₀alkoxy, C₃-C₁₀cycloalkyl, C₆-C₁₀aryl, C₆-C₁₀arylC₁-C₁₀alkyl, C₁-C₁₀ alkylC₆-C₁₀aryl, triC₁-C₁₀alkylsilyl, or triC₆-C₁₀arylsilyl, or each of the R₅ to R₁₂ may be linked to an adjacent substituent via C₃-C₁₂alkylene or C₃-C₁₂alkenylene with or without a fused ring to form an alicyclic ring or form a monocyclic or polycyclic aromatic ring;
R₁₃ and R₁₄ are independently of each other C₆-C₁₀aryl;
X is conjugated or non-conjugated C₄-C₁₀diene;
the diene may be further substituted by one or two or more substituents selected from the group consisting of C₁-C₁₀alkyl, C₃-C₁₀cycloalkyl, C₆-C₁₀aryl, C₆-C₁₀arylC₁-C₁₀alkyl, C₁-C₁₀alkylC₆-C₁₀aryl, C₁-C₁₀alkoxy, C₆-C₁₀aryloxy, triC₁-C₁₀alkylsilyl, and triC₆-C₁₀arylsilyl; and
the diene forms a π-complex with a central metal M.

3. The transition metal compound of claim 1, wherein in Chemical Formula 1,
M is Ti, Zr, or Hf;
A is carbon or silicon;
R₁ to R₄ are independently of one another hydrogen or C₁-C₄alkyl;
R₅ to R₁₂ are independently of one another hydrogen, C₁-C₄alkyl, or C₁-C₄alkoxy;
R₁₃ and R₁₄ are independently of each other C₆-C₁₀aryl;
X is conjugated or non-conjugated C₄-C₇diene;
the diene may be further substituted by one or two or more substituents selected from the group consisting of C₁-C₁₀alkyl, C₃-C₁₀cycloalkyl, C₆-C₁₀aryl, C₆-C₁₀arylC₁-C₁₀alkyl, C₁-C₁₀alkylC₆-C₁₀aryl, C₁-C₁₀alkoxy, C₆-C₁₀aryloxy, triC₁-C₁₀alkylsilyl, and triC₆-C₁₀arylsilyl; and
the diene forms a π-complex with a central metal M.

4. The transition metal compound of claim 1, wherein the transition metal compound is represented by the following Chemical Formula 2: 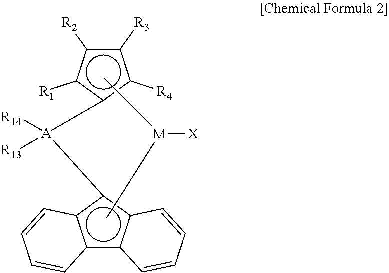
wherein
M is Ti, Zr, or Hf;
A is carbon or silicon;
R₁ to R₄ are independently of one another hydrogen or C₁-C₄alkyl;
R₁₃ and R₁₄ are independently of each other C₆-C₁₀aryl;
X is 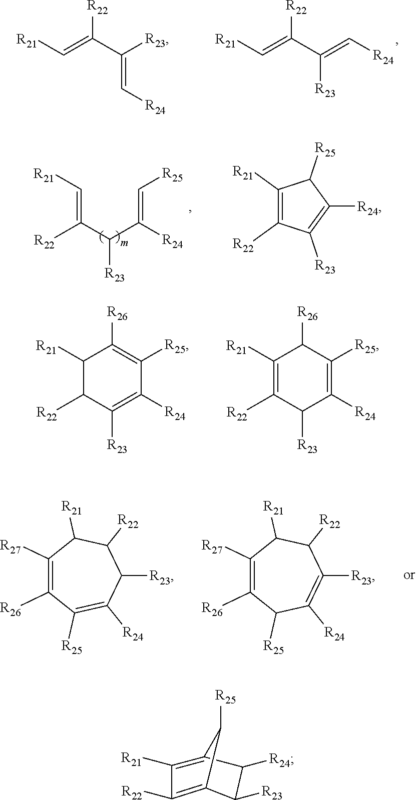
R₂₁ to R₂₇ are independently of one another hydrogen, C₁-C₁₀alkyl, C₃-C₁₀cycloalkyl, C₆-C₁₀aryl, C₆-C₁₀arylC₁-C₁₀alkyl, C₁-C₁₀alkylC₆-C₁₀aryl, C₁-C₁₀alkoxy, C₆-C₁₀aryloxy, triC₁-C₁₀alkylsilyl, or triC₆-C₁₀arylsilyl;
m is an integer of 1 to 3; and
X forms a π-complex with a central metal M.

5. The transition metal compound of claim 1, wherein the transition metal compound is selected from the following compounds:

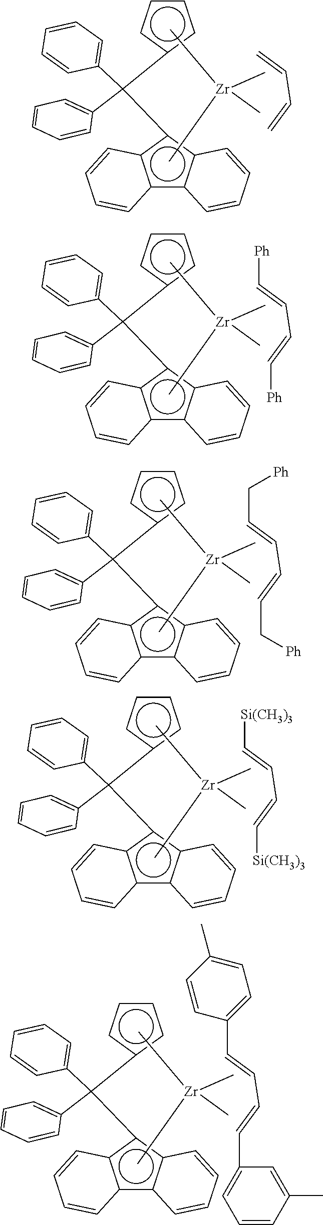

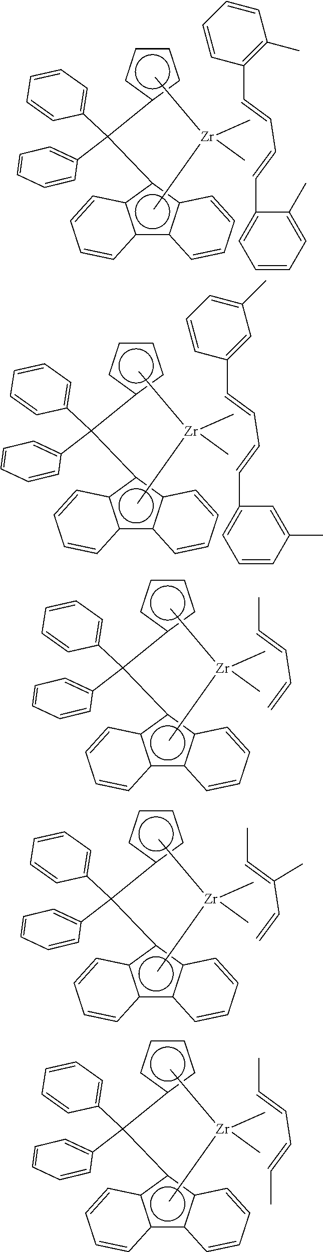

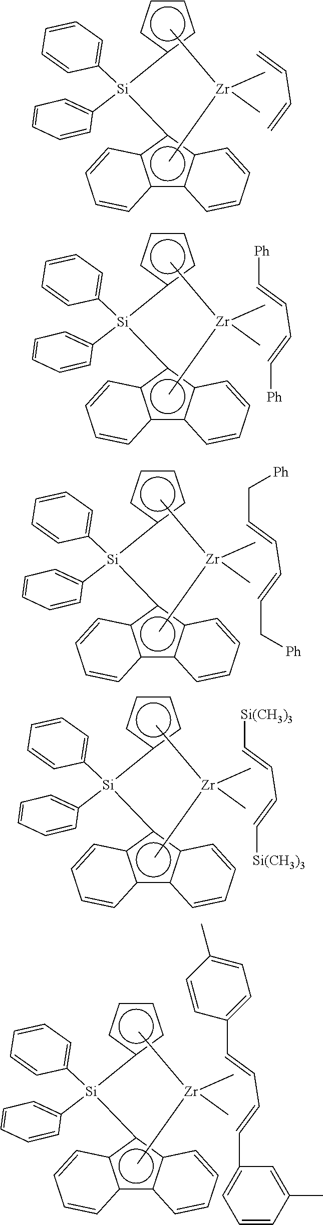

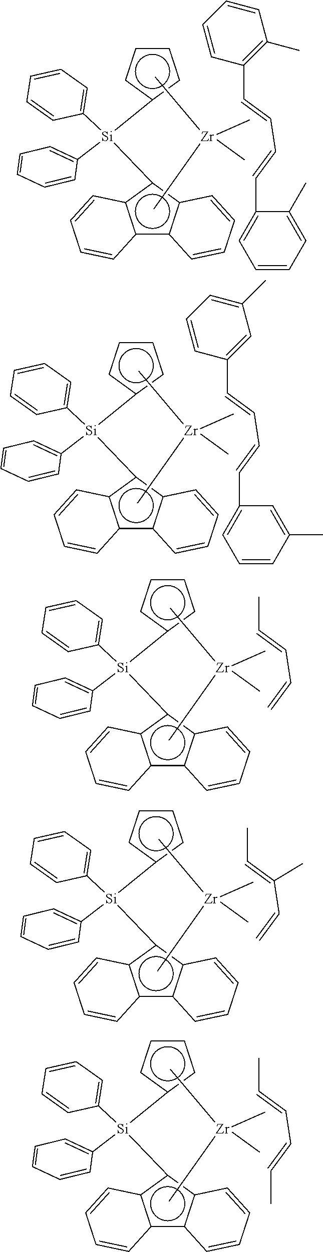

6. The transition metal compound of claim 1, wherein the transition metal compound has a solubility in methylcyclohexane of 5 wt % or more at 25° C.

7. A transition metal catalyst composition for preparing an ethylene homopolymer or a copolymer of ethylene and α-olefin, comprising:
a transition metal compound represented by the following Chemical Formula 1; and
a cocatalyst: 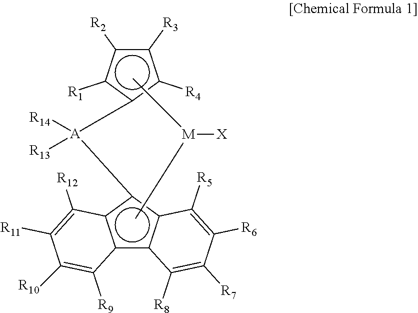
wherein
M is a Group 4 transition metal in the periodic table;
A is carbon or silicon;
R₁ to R₄ are independently of one another hydrogen or C₁-C₂₀alkyl;
R₅ to R₁₂ are independently of one another hydrogen, C₁-C₂₀alkyl, C₁-C₂₀alkoxy, C₃-C₂₀cycloalkyl, C₆-C₂₀aryl, C₆-C₂₀arylC₁-C₂₀alkyl, C₁-C₂₀ alkylC₆-C₂₀aryl, triC₁-C₂₀alkylsilyl, or triC₆-C₂₀arylsilyl, or each of the R₅ to R₁₂ may be linked to an adjacent substituent via C₃-C₁₂alkylene or C₃-C₁₂alkenylene with or without a fused ring to form an alicyclic ring or form a monocyclic or polycyclic aromatic ring;
R₁₃ and R₁₄ are independently of each other C₆-C₂₀aryl;
X is conjugated or non-conjugated C₄-C₂₀diene;
the diene may be further substituted by one or two or more substituents selected from the group consisting of C₁-C₂₀alkyl, C₃-C₂₀cycloalkyl, C₆-C₂₀aryl, C₆-C₂₀arylC₁-C₂₀alkyl, C₁-C₂₀alkylC₆-C₂₀aryl, C₁-C₂₀alkoxy, C₆-C₂₀aryloxy, triC₁-C₂₀alkylsilyl, and triC₆-C₂₀arylsilyl; and
the diene forms a π-complex with a central metal M.

8. The transition metal catalyst composition of claim 7, wherein the co-catalyst is an aluminum compound cocatalyst, a boron compound co-catalyst, or a mixture thereof.

9. A method for preparing an olefin polymer, the method comprising:
obtaining an olefin polymer by solution polymerization of one or two or more monomers selected from ethylene and α-olefins in the presence of a transition metal compound represented by Chemical Formula 1, a cocatalyst, and a non-aromatic hydrocarbon solvent: 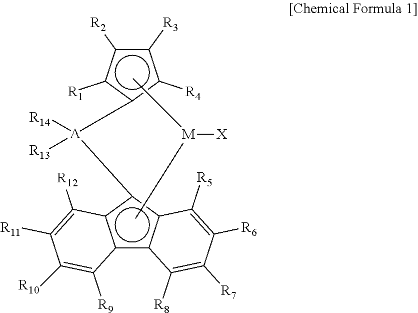
wherein
M is a Group 4 transition metal in the periodic table;
A is carbon or silicon;
R₁ to R₄ are independently of one another hydrogen or C₁-C₂₀alkyl;
R₅ to R₁₂ are independently of one another hydrogen, C₁-C₂₀alkyl, C₁-C₂₀alkoxy, C₃-C₂₀cycloalkyl, C₆-C₂₀aryl, C₆-C₂₀arylC₁-C₂₀alkyl, C₁-C₂₀ alkylC₆-C₂₀aryl, triC₁-C₂₀alkylsilyl, or triC₆-C₂₀arylsilyl, or each of the R₅ to R₁₂ may be linked to an adjacent substituent via C₃-C₁₂alkylene or C₃-C₁₂alkenylene with or without a fused ring to form an alicyclic ring or form a monocyclic or polycyclic aromatic ring;
R₁₃ and R₁₄ are independently of each other C₆-C₂₀aryl;
X is conjugated or non-conjugated C₄-C₂₀diene;
the diene may be further substituted by one or two or more substituents selected from the group consisting of C₁-C₂₀alkyl, C₃-C₂₀cycloalkyl, C₆-C₂₀aryl, C₆-C₂₀arylC₁-C₂₀alkyl, C₁-C₂₀alkylC₆-C₂₀aryl, C₁-C₂₀alkoxy, C₆-C₂₀aryloxy, triC₁-C₂₀alkylsilyl, and triC₆-C₂₀arylsilyl; and
the diene forms a π-complex with a central metal M.

10. The method for preparing an olefin polymer of claim 9, wherein the non-aromatic hydrocarbon solvent is one or two or more selected from the group consisting of methylcyclohexane, cyclohexane, n-heptane, n-hexane, n-butane, isobutane, n-pentane, n-octane, isooctane, nonane, decane, and dodecane.

11. The method for preparing an olefin polymer of claim 9, wherein a solubility of the transition metal compound in the non-aromatic hydrocarbon solvent is 5 wt % or more at 25° C.

12. The method for preparing an olefin polymer of claim 9, wherein the co-catalyst is an aluminum compound cocatalyst, a boron compound co-catalyst, or a mixture thereof.

13. The method for preparing an olefin polymer of claim 12, wherein the boron compound cocatalyst is compounds represented by the following Chemical Formulae 11 to 14:
BR³¹₃ [Chemical Formula 11]
[R³²]⁺[BR³¹₄]⁻ [Chemical Formula 12]
[R³³ₚZH]⁺[BR³¹₄]⁻ [Chemical Formula 13] 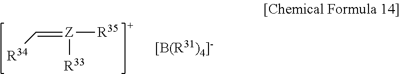
wherein
B is a boron atom;
R³¹ is phenyl, and the phenyl may be further substituted by 3 to 5 substituents selected from the group consisting of a fluorine atom, C₁-C₂₀ alkyl, C₁-C₂₀alkyl substituted by a fluorine atom, C₁-C₂₀alkoxy, and C₁-C₂₀alkoxy substituted by a fluorine atom;
R³² is a C₅-C₇aromatic radical, a C₁-C₂₀alkylC₆-C₂₀aryl radical, or a C₆-C₂₀arylC₁-C₂₀alkyl radical;
Z is nitrogen or a phosphorous atom;
R³³ is a C₁-C₂₀alkyl radical or an anilinium radical substituted by two C₁-C₁₀alkyls together with a nitrogen atom;
R³⁴ is C₅-C₂₀alkyl;
R³⁵ is C₅-C₂₀aryl or C₁-C₂₀alkylC₆-C₂₀aryl; and
p is an integer of 2 or 3.

14. The method for preparing an olefin polymer of claim 12, wherein the aluminum compound cocatalyst is compounds represented by the following Chemical Formulae 15 to 19:
—(Al(R⁴¹)—O)ᵣ— [Chemical Formula 15]
(R⁴²)₂Al—(—O(R⁴²)—)ₛ—O—Al(R⁴²)₂ [Chemical Formula 16]
(R⁴³)ₜAl(E)₃₋ₜ [Chemical Formula 17]
(R⁴⁴)₂AlOR⁴⁵ [Chemical Formula 18]
R⁴⁴Al(OR⁴⁵)₂ [Chemical Formula 19]
wherein
R⁴¹ and R⁴² are independently of each other C₁-C₂₀alkyl;
r and s are independently of each other an integer of 5 to 20;
R⁴³ and R⁴⁴ are independently of each other C₁-C₂₀alkyl;
E is hydrogen or halogen;
t is an integer of 1 to 3; and
R⁴⁵ is C₁-C₂₀alkyl or C₆-C₃₀aryl.

15. The method for preparing an olefin polymer of claim 9, wherein the solution polymerization is performed at 100 to 220° C.
